(19) United States
(12) Patent Application Publication
(10) Pub. No.: US 2009/0197054 A1
(43) Pub. Date: Aug. 6, 2009

(54) Stencils With Removable Backings for Forming Micron-Sized Features on Surfaces and Methods of Making and Using the Same

(75) Inventors: Karan CHAUHAN, Cambridge, MA (US); Joseph M. MCLELLAN, Somerville, MA (US); Sandip Agarwal, Somerville, MA (US); Brian T. MAYERS, Somerville, MA (US); Jeffrey Carbeck, Belmont, MA (US); Ralf Kugler, Cambridge, MA (US); Monika Kursawe, Seeheim-Jugenheim (DE)

Correspondence Address: STERNE, KESSLER, GOLDSTEIN & FOX P.L.L.C., 1100 NEW YORK AVENUE, N.W., WASHINGTON, DC, 20005, US

(73) Assignees: Nano Terra Inc., Cambridge, MA (US); Merck Patent GmbH, Darmstadt (DE)

(21) Appl. No.: 12/237,754

(22) Filed: Sep. 25, 2008

Related U.S. Application Data
(60) Provisional application No. 61/026,591, filed on Feb. 6, 2008.

(51) Int. Cl. B32B 3/10; B32B 37/02; B41M 1/12

(52) U.S. Cl. 428/195.1; 156/247; 101/129; 101/128.21

(57) ABSTRACT

The present invention is directed to methods for patterning substrates using elastomeric stencils having removable backings and methods of preparing the stencils.

### CROSS REFERENCE TO RELATED APPLICATIONS

This application claims the benefit of the filing date of U.S. Application No. 61/026,591, filed Feb. 6, 2008, which is incorporated herein by reference in its entirety.

### BACKGROUND OF THE INVENTION

1. Field of the Invention

The present invention is directed to methods for patterning substrates using contact printing methods that employ an elastomeric stencil having a removable backing.

2. Background

Methods of patterning substrates are well known and include photolithography techniques, as well as the more recently developed soft-contact printing techniques such as “micro-contact printing” (see, e.g., U.S. Pat. No. 5,512,131).

Traditional photolithography methods, while versatile in the architectures and compositions of surface features that can be formed, are also costly and require specialized equipment. Moreover, photolithography techniques have difficulty patterning very large substrates, non-planar substrates, and/or non-rigid substrates such as, for example, textiles, paper, plastics, and the like.

Stenciling is a common technique that is used frequently for patterning substrates having large surface areas. Stencils are inexpensive to fabricate and a wide variety of paste and ink compositions enable many different types of surface features to be formed. However, the lateral dimensions of surface features formed by stenciling are typically limited by the difficulty in preparing and using stencils having openings with high aspect ratios. The fabrication of thinner stencils can result in difficulties in handling, applying and aligning the stencils on a substrate.

What is needed is a stencil and a method of using the stencil that can achieve lateral dimensions below 50 μm using standard paste and ink compositions.

### BRIEF SUMMARY OF THE INVENTION

The present invention is directed to methods for patterning substrates using stenciling techniques that employ a stencil having a removable backing. Surface features formed by this method have at least one lateral dimension that is less than 50 μm, and permit all varieties of substrates to be patterned in a cost-effective, efficient, and reproducible manner.

The present invention is directed to a method for forming a surface feature on a substrate, the method comprising:
(a) providing an elastomeric stencil having:
   an elastomeric material having a front surface and a back surface including an opening therethrough, the opening defining a pattern in the surfaces of the elastomeric material, wherein the opening has at least one lateral dimension of about 50 μm or less, and wherein the elastomeric material has a thickness not greater than ten times the minimum lateral dimension; and
   a removable backing layer adhered to the back surface of the elastomeric material;
(b) conformally contacting the front surface of the elastomeric stencil with a substrate;
(c) removing the backing layer from the elastomeric stencil;
(d) applying a reactive composition to the opening in the elastomeric stencil;
(e) reacting the reactive composition with the substrate to produce a surface feature thereon, wherein the lateral dimension of the opening in the elastomeric stencil defines a lateral dimension of the surface feature produced by the reacting; and
(f) separating the front surface of the elastomeric stencil from the patterned substrate.

In some embodiments, the removing further comprises: exposing the backing layer to a solvent.

In some embodiments, the conformally contacting is promoted by at least one of: applying pressure to the back of the elastomeric stencil, applying a vacuum to the interface between the elastomeric stencil and the substrate, wetting one or both of the surfaces of the elastomeric stencil and the substrate, applying an adhesive to one or both of the elastomeric stencil and the substrate, and combinations thereof.

The present invention is also directed to a product prepared by any of the above methods.

The present invention is also directed to a method for forming an elastomeric stencil, the method comprising:
(a) providing a master having a protrusion thereon having at least one lateral dimension of about 50 μm or less;
(b) providing an elastomeric material on the master, wherein the elastomeric material includes a front surface in contact with the master and a back surface, and wherein the elastomeric material has a thickness less than the elevation of the at least one protrusion;
(c) disposing a backing layer onto the elastomeric material to substantially cover both the elastomeric material and the at least one protrusion, wherein the backing layer and the elastomeric material are reversibly bonded; and
(d) separating the elastomeric material and backing layer from the master, thereby providing the elastomeric stencil, wherein the elastomeric material has a front surface and a back surface including at least one opening therethrough, the opening defining a pattern in the surfaces of the elastomeric material, wherein the opening has a lateral dimension defined by the protrusion, and wherein the elastomeric material has a thickness not greater than ten times the minimum lateral dimension.

In some embodiments, the method further comprises: after the disposing, curing the backing layer. In some embodiments, the curing comprises at least one of: exposing to thermal energy, exposing to ultraviolet (“UV”) light, exposing to electrical current, exposing to infrared (“IR”) light, exposing to a plasma, exposing to oxidizing reagents, and combinations thereof.

In some embodiments, the method further comprises after the disposing, adhering a rigid or semi-rigid support layer to an outer surface of the backing layer.

The present invention is also directed to a kit for patterning a substrate, the kit comprising:
(a) an elastomeric stencil that includes
   an elastomeric material having a front surface and a back surface including at least one opening therethrough, the opening defining a pattern in the surfaces of the elastomeric material, wherein the opening has at least one lateral dimension of about 50 μm or less, and wherein the elastomeric material has a thickness not greater than ten times the minimum lateral dimension,
   a peelable protective layer adhered to the front surface of the elastomeric material, and
   a removable backing layer adhered to the back surface of the elastomeric material; and
(b) instructions directing patterning a substrate using the elastomeric stencil.

In some embodiments, the kit further comprises a reactive composition filling the at least one opening.

In some embodiments, the elastomeric material is substantially homogeneous. In some embodiments, the front surface of the elastomeric material has a surface area of about 500 mm² or more.

In some embodiments, the stencil further comprises a rigid or semi-rigid support layer adhered to an outer surface of the removable backing layer. In some embodiments, the stencil further comprises a non-permeable seal surrounding an outer edge of the elastomeric material.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 provides a three-dimensional schematic representation of a master suitable for use with the present invention.

FIGS. 2A, 2B and 2C and FIGS. 2D, 2E and 2F provide a three-dimensional schematic representation of a method of the present invention for fabricating a stencil and applying the stencil to a substrate.

FIGS. 3A, 3B, 3C, 3D, 3E, 3F and 3G provide schematic cross-sectional representations of a method of the present invention suitable for preparing a stencil having an removable backing, and applying the stencil to a substrate to form a pattern thereon.

FIGS. 4A, 4B, 4C, 4D, 4E, 4F and 4G provide schematic cross-sectional representations of substrates having surface features thereon that can be prepared by a method of the present invention.

FIG. 5 provides a schematic cross-sectional representation of a curved substrate comprising surface features produced by a method of the present invention.

FIG. 6 and FIG. 7 provide photographic images of gold-coated substrates patterned using a method of the present invention.

FIG. 8 and FIG. 9 provide transmission mode optical microscopy images of gold-coated substrates patterned using a method of the present invention.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

### Stencils

In some embodiments, the present invention is directed to an elastomeric stencil comprising:
(a) an elastomeric material having a front surface and a back surface including an opening therethrough, the opening defining a pattern in the surfaces of the elastomeric material, wherein the opening has a minimum lateral dimension of about 50 μm or less, and wherein the elastomeric material has a thickness not greater than ten times the minimum lateral dimension; and
(b) a removable backing layer.

As used herein, a “stencil” refers to a molded three dimensional object having at least one opening that penetrates through two opposite surfaces of the object to form an opening in the surfaces of the object, the opening defining a pattern in the surfaces of the object. The opening enables a solid, liquid, or gaseous reactive substance, such as, but not limited to, an ink or paste to be applied to the backside of the stencil and contact a substrate in a pattern according to the pattern of openings in the elastomeric material. Stencils for use with the present invention are not particularly limited by geometry, and can be flat, curved, smooth, rough, wavy, and combinations thereof. In some embodiments, a stencil can have a three dimensional shape suitable for conformally contacting a substrate.

Stencils for use with the present invention can be prepared from elastomeric materials such as, but not limited to, polydimethylsiloxane, polysilsesquioxane, polyisoprene, polybutadiene, polychloroprene, teflon, polycarbonate resins, cross-linked epoxy resins, acryloxy perfluoropolyethers, alkylacryloxy perfluoropolyethers, and the like, and combinations thereof, and any other elastomeric materials known to persons of ordinary skill in the polymer arts. Other materials and methods to prepare elastomeric stencils suitable for use with the present invention are disclosed in U.S. Pat. Nos. 5,512,131; 5,900,160; 6,180,239; 6,776,094; and 7,342,494, all of which are incorporated herein by reference in their entirety. In some embodiments, the composition of the elastomeric material is substantially homogeneous. In some embodiments, the composition of the elastomeric material has a gradient, or a multi-laminate structure.

A stencil of the present invention includes at least one opening having lateral dimension of at least about 50 μm or less. In some embodiments, a stencil of the present invention includes at least one opening having lateral dimension of at least about 40 μm or less, about 30 μm or less, about 20 μm or less, about 10 μm or less, about 5 μm or less, about 1 μm or less, or about 0.5 μm or less. In some embodiments, a stencil of the present invention includes at least one opening having lateral dimension of about 0.1 μm to about 50 μm, about 0.1 μm to about 40 μm, about 0.1 μm to about 30 μm, about 0.1 μm to about 20 μm, about 0.1 μm to about 10 μm, about 0.1 μm to about 1 μm, about 0.5 μm to about 50 μm, about 0.5 μm to about 40 μm, about 0.5 μm to about 30 μm, about 0.5 μm to about 20 μm, about 0.5 μm to about 10 μm, about 0.5 μm to about 1 μm, about 1 μm to about 50 μm, about 1 μm to about 40 μm, about 1 μm to about 30 μm, about 1 μm to about 20 μm, about 1 μm to about 10 μm, about 5 μm to about 50 μm, about 5 μm to about 25 μm, about 10 μm to about 50 μm, or about 10 μm to about 25 μm.

The stencils of the present invention can have a thickness of about 100 nm to about 500 μm. In some embodiments, the stencils of the present invention have a thickness of about 100 nm to about 400 μm, about, about 150 nm to about 300 μm, about 200 nm to about 250 μm, about 250 nm to about 200 μm, about 300 nm to about 150 μm, about 400 nm to about 100 μm, about 500 nm to about 80 μm, about 600 nm to about 60 μm, about 700 nm to about 50 μm, about 800 nm to about 40 μm, about 900 nm to about 35 μm, about 1 μm to about 30 μm, about 1.5 μm to about 30 μm, about 2 μm to about 30 μm, about 2.5 μm to about 30 μm, about 3 μm to about 30 μm, about 5 μm to about 30 μm, about 10 μm to about 30 μm, about 15 μm to about 50 μm, about 20 μm to about 50 μm, or about 25 μm to about 50 μm.

In some embodiments, the stencils of the present invention have a thickness not greater than about 10 times the minimum lateral dimension of the at least one opening. In some embodiments, the stencils of the present invention have a thickness not greater than about 8 times, about 5 times, about 4 times, about 3 times, about 2 times, about 1.5 times, about equal, about 0.9 times, about 0.8 times, about 0.7 times, about 0.5 times, about 0.3 times, about 0.2 times, about 0.1 times, about 0.05 times, or about 0.01 times the minimum lateral dimension of the at least one opening.

In some embodiments, the front surface of the stencil (i.e., the front surface of the elastomeric material) has a surface area of about 500 mm or more. In some embodiments, the front surface of the stencil has a surface area of about 1,000 mm² or more, about 5,000 mm² or more, about 10,000 mm² or more, about 20,000 mm² or more, about 50,000 mm², about 75,000 mm² or more, about 100,000 mm² or more, or about 150,000 mm² or more.

The stencil further includes a removable backing layer adhered to the back surface of the elastomeric material. The removable backing layer enables the stencil to be easily handled, aligned, and applied to a substrate. In some embodiments, the removable backing layer includes additional material that extends over the sides of the elastomeric material (i.e., the surface area of the removable backing layer is greater than the surface area of the backside of the elastomeric material). This can permit the stencil to be lifted, positioned and applied to a substrate without touching or contacting the front surface of the elastomeric material.

The removable backing layer comprises a material such that it can be easily removed from the elastomeric material after contacting the stencil with a substrate. In some embodiments, the backing layer is removed from the elastomeric stencil by peeling the backing layer from the back surface of the stencil. In some embodiments, the backing layer is removed from the elastomeric stencil by a chemical means such as, but not limited to, a solvent suitable for dissolving the backing layer, a gaseous reagent capable of breaking a covalent bond between the stencil and the backing layer, and the like, and combinations thereof. In some embodiments, the backing layer is removed from the elastomeric stencil by a electromagnetic means such as, but not limited to, a magnetic force applied to the backing layer (i.e., for a paramagnetic backing layer), an electromagnetic pulse capable of disrupting an adhesive interaction between the backing layer and the elastomeric stencil (e.g., UV radiation, a plasma, and the like), dissipation or disruption of a static electrical charge, and combinations thereof.

In some embodiments, the backing layer is removed by dissolving the backing layer in a solvent (e.g., water, ethanol, acetone, and the like) in which the elastomeric material is substantially insoluble (e.g., a solvent in which the elastomeric material has a solubility of about 20% or less, about 15% or less, about 10% or less, about 5% or less, about 2% or less, or about 1% or less by weight). In addition to being unable to dissolve the elastomeric material, preferred solvents also do not induce substantial swelling in the elastomeric material that can lead, for example, to a loss of feature size, penetration of a reactive composition into the elastomeric stencil, a failure to properly adhere to the substrate during the patterning, or a failure to be easily removed from the substrate after patterning, and combinations thereof. The loss of feature size and/or distortion of the stencil pattern can be particularly problematic for “floating” stencils that include portions that are physically disconnected from one another for example, such as a stencil in the shape of the letter “i” or “j”. In some embodiments, the present invention is directed to a floating stencil having a removable backing layer thereon, in which the removable backing layer can be removed without distorting the feature size or pattern of the floating stencil.

In some embodiments, the backing layer is removed from the elastomeric stencil using a solvent that induces an increase in the minimum lateral dimension of the stencil of about 15% or less, about 10% or less, about 5% or less, about 2% or less, or about 1% or less. In some embodiments, the backing layer is removed from the elastomeric stencil using a solvent that induces an increase in the volume of the elastomeric stencil of about 15% or less, about 10% or less, about 5% or less, about 2% or less, or about 1% or less. In some embodiments, the backing layer is removed from the elastomeric stencil using a combination of chemical

In some embodiments, the removable backing layer includes an adhesive such as, but not limited to, a water-soluble adhesive (e.g., an adhesive based on a poly(vinylacetate), a poly(vinylalcohol), a poly(vinylpyrrolidone), a hydroxypropylcellulose, a polyamide, a vinylpyrrolidone-vinylacetate copolymer, and the like), a pressure-sensitive adhesive, and combinations thereof. In some embodiments, the removable backing layer comprises a material that can undergo out-of-plane distortions such as rolling, bending, curving, folding, and the like, but which is resistant to in-the-plane distortions such as elastic and/or plastic deformation of the length, width, height, or depth of the backing layer.

Generally, the removable backing layer does not decrease the flexibility of the elastomeric stencil, thereby permitting the stencil to be peeled, folded, stretched, and the like, without damage to the elastomeric stencil. In some embodiments, the removable backing layer can be flexible but inextensible, thereby allowing the stencil to be rolled, bent, curved, folded, and the like, without distorting the pattern in the surface of the stencil.

In some embodiments, the backing layer is optically clear or optically translucent, thereby permitting optical alignment of the stencil on a substrate. For example, in some embodiments the removable backing layer is at least 25%, at least about 50%, at least about 60%, at least about 70%, at least about 80%, at least about 85%, at least about 90%, at least about 95%, or at least about 99%, optically transmissive to one or more wavelengths in the IR, visible or UV regions of the electromagnetic spectrum.

In some embodiments, the backing layer can be recycled and/or regenerated such that the backing layer is re-applied to the stencil after the patterning. For example, in some embodiments a backing layer adhered to the stencil using an adhesive can be re-applied to the stencil using an additional adhesive, a pressure sensitive adhesive, and the like. In some embodiments, a backing layer adhered to the stencil by a magnetic force or a static charge can be re-applied using the same magnetic force, or by induction of a static charge. In some embodiments, a backing layer adhered to the stencil by a chemical bond can be re-functionalized with a reactive chemical group suitable for interacting with the surface of the stencil, and the like. In some embodiments, a backing layer that is removed from the stencil by dissolving in a solvent can be at least partially evaporated, re-applied to the stencil and dried.

In some embodiments, the elastomeric stencil further includes a rigid or semi-rigid support layer. The rigid or semi-rigid support layer can be attached to the outside of the removable backing layer or incorporated into the removable backing layer. As used herein, a rigid or semi-rigid support refers to an element that can be applied to the backside of the removable backing layer, or embedded in the removable backing layer, that lends structural support to the stencil. In some embodiments, the rigid or semi-rigid support has a higher modulus than the elastomeric material and the removable backing layer. In some embodiments, the rigid or semi-rigid support has a thickness greater than either of the elastomeric material and the removable backing layer. Materials suitable for use as rigid or semi-rigid supports of the present invention include, but are not limited to, a metal, a ceramic, fibrous materials (e.g., cloth, wood, mesh, and the like), a polymeric material (e.g., a polyvinylchloride, mylar, a polycarbonate, a polyurethane, and the like), and combinations thereof.

In some embodiments, the elastomeric stencil further includes a removable protective sheet adhered to the front of the elastomer. For example, a removable protective sheet can comprise a thin plastic sheet adhered to the front of the elastomeric stencil using a pressure-sensitive or water-soluble adhesive. The protective sheet can prevent the stencil from becoming damaged during storage, and can also prevent degradation (e.g., oxidation) of the front surface of the elastomeric material, or degradation of a reactive substance contained within the openings of the elastomeric material. Generally, the protective sheet is removed prior to conformally contacting the stencil to a substrate. However, it is also within the scope of the present invention that the protective sheet is not removed from the stencil prior to conformally contacting the stencil with a substrate, but is instead dissolved using a solvent, or otherwise dissolved, reacted, consumed, destroyed, and the like by a reactive composition applied to the substrate through an opening in the stencil.

### Methods of Preparing the Stencils

The present invention is directed to a method for forming an elastomeric stencil, the method comprising:
(a) providing a master having a protrusion thereon having a minimum lateral dimension of about 50 μm or less;
(b) providing an elastomeric material on the master, wherein the elastomeric material includes a front surface in contact with the master and a back surface, and wherein the elastomeric material has a thickness less than the elevation of the at least one protrusion;
(c) disposing a removable backing layer onto the elastomeric material to substantially cover both the elastomeric material and the at least one protrusion, wherein the removable backing layer and the elastomeric material are reversibly bonded; and
(d) separating the elastomeric material and removable backing layer from the master, thereby providing the elastomeric stencil, wherein the an elastomeric material has a front surface and a back surface including at least one opening therethrough, the opening defining a pattern in the surfaces of the elastomeric material, wherein the opening has a lateral dimension defined by the protrusion, and wherein the elastomeric material has a thickness not greater than ten times the minimum lateral dimension.

As used herein, a “master” refers to a template suitable for manufacturing an elastomeric stencil. Masters for use with the present invention include a surface having at least one protrusion thereon. Masters for use with the present invention are not particularly limited by geometry, and can be flat, curved, smooth, rough, wavy, and combinations thereof. Masters are not particularly limited by composition. Typically, masters for use with the present invention are non-porous solids. However, porous solids, flexible solids (e.g., elastomers), deformable solids, and the like can be used as masters with the present invention. Materials suitable for use as masters include any materials that do not form a bond with an elastomeric material or an elastomeric precursor (i.e., it must be possible to remove the elastomeric stencil from the master). Materials suitable for use as masters include, but are not limited to, metals, alloys, composites, crystalline materials, amorphous materials, conductors, semiconductors, glasses, ceramics, plastics, laminates, polymers, minerals, and combinations thereof. In some embodiments, a material suitable for use as a master can be selected based upon one or more of its physical properties, electrical properties, optical properties, thermal properties, and combinations thereof. Masters can be prepared using traditional lithographic processes, ion-beam etching processes, and the like.

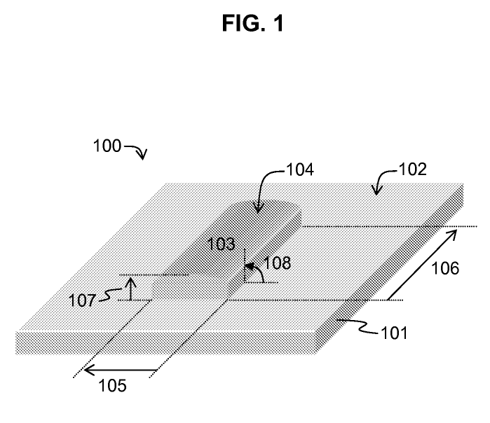

FIG. 1 provides a three-dimensional schematic representation of a master, 100, suitable for use with the present invention. Referring to FIG. 1, the master, 100, includes a material, 101, having a surface, 102, with at least one protrusion, 103, thereon. The at least one protrusion, 103, can have any shape (as viewed from above), including symmetric and asymmetric shapes, rectilinear and curved shapes, and combinations thereof. In some embodiments, a pattern can be formed by repeating the at least one protrusion across the surface of the master. The at least one protrusion, 103, has a top surface, 104, that can be flat, convex (as shown in FIG. 1), or concave. The protrusion can be made of the same or a different material as the master.

The protrusion on a master for use with the present invention has a minimum lateral dimension of about 50 μm or less. As used herein, a “lateral dimension” refers to a dimension of a protrusion that is measured in the plane of the master (for a master having a planar surface), or along the curvature of the surface of the master (for a non-planar master). One or more lateral dimensions of a protrusion define, or can be used to define, the size and shape of an opening that is formed in an elastomeric material. Typical lateral dimensions of protrusions include, but are not limited to: length, width, radius, diameter, and combinations thereof. A lateral dimension of a protrusion having a rectilinear shape on a planar master can be determined by the magnitude of one or more vectors lying in the plane of the master, 105 and 106, respectively, that connect points lying on opposite sides of the protrusion. At least one of the lateral dimensions of a protrusion is about 50 μm or less. For a master having more than one protrusion, at least one of the lateral dimensions of at least one of the protrusions has a lateral dimension of about 50 μm or less (i.e., for a master having more than one protrusion, not every protrusion must have at least one lateral dimension of about 50 μm or less).

Referring to FIG. 1, the protrusion, 103, has an elevation (i.e., a height), 107, that can be determined by the magnitude of a vector orthogonal to the surface of the master connecting the base of the protrusion with the highest point on the protrusion. The height, 107, of a protrusion is greater than the thickness of an elastomeric material or the depth of an elastomeric precursor that is applied to the master.

Referring to FIG. 1, the base of the protrusion forms an angle, 108, with the surface of the master, 102. In some embodiments, the angle, 108, is about 90° (i.e., is orthogonal with the substrate, 101). In some embodiments, the angle formed between the base of the protrusion and the surface of the master is about 45° to about 135°, about 60° to about 120°, or about 75° to about 105°.

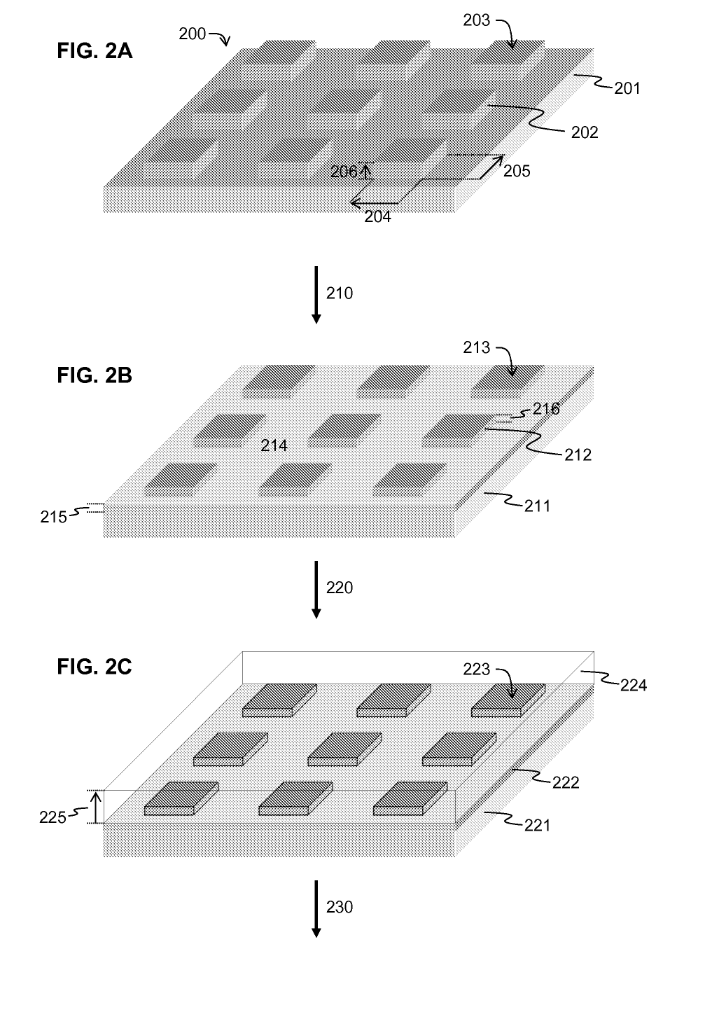

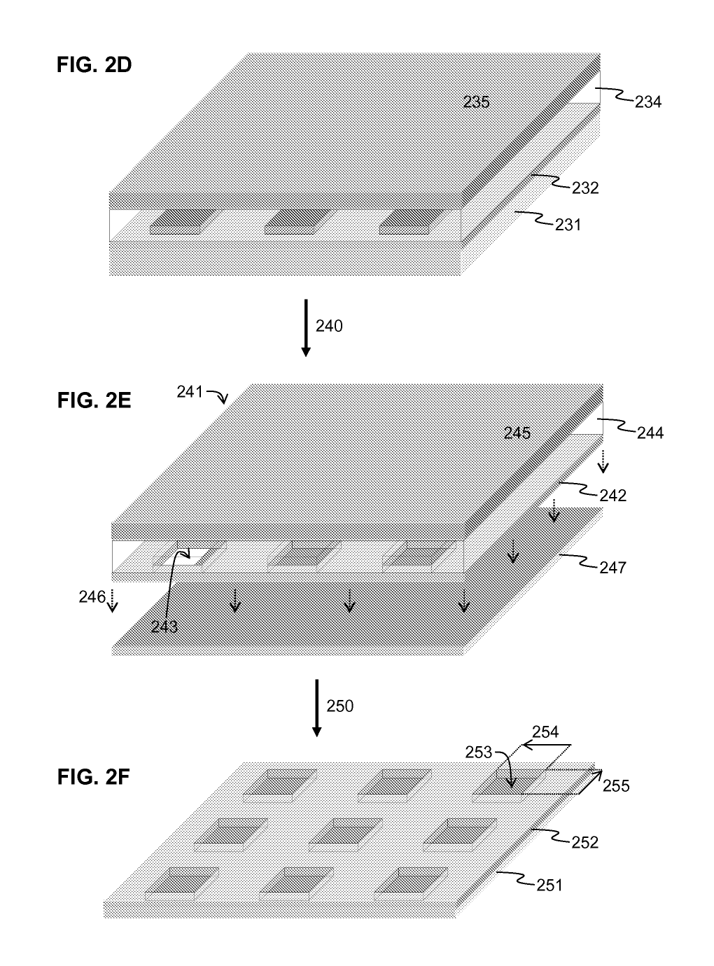

FIGS. 2A-2C and FIGS. 2D-2F provide a three-dimensional schematic representation of a method for preparing an elastomeric stencil of the present invention, and applying the stencil having a removable backing to a substrate to form a pattern thereon. Referring to FIG. 2A, a master, 200, is provided that includes a material, 201, having at least one protrusion thereon, 202. The protrusion has a top surface, 203, a lateral dimension indicated by the magnitude of the vectors, 204 and 205, respectively, and an elevation indicated by the magnitude of the vector, 206.

An elastomeric material or an elastomeric precursor is applied to the master, 210. Suitable methods for applying the elastomeric material or the elastomeric precursor to the master include, but are not limited to, spin-coating, spraying, ink-jet depositing, atomizing, chemical vapor depositing, and combinations thereof. The present invention also contemplates the utilization of a conformal deposition process (e.g., plasma enhanced chemical vapor deposition, hot wire chemical vapor deposition, thermal deposition, and combinations thereof), followed by removal of the elastomeric material or elastomeric precursor from the upper surfaces of the protrusion.

Referring to FIG. 2B, an elastomeric material or an elastomeric precursor, 214, is provided on the master, 211. In some embodiments, an elastomeric precursor is deposited and then cured or cross-linked to provide an elastomer. Alternatively, an elastomeric material can be provided directly, for example, by chemical vapor deposition. The elastomeric material has a thickness, 215, that is less than the elevation of the protrusion, 212. Thus, the surface of the protrusion, 213, protrudes above the elastomeric material at a height, 216.

A removable backing layer is then applied, 220, to the elastomeric material and the protrusions of the master. In some embodiments, the removable backing layer is deposited as a precursor and then cured, dried, and/or polymerized. Suitable methods for applying the removable backing layer include, but are not limited to, spin-coating, spraying, ink-jet depositing, atomizing, chemical vapor depositing, adhering (e.g., applying an adhesive followed by rolling or applying a pre-formed backing layer onto the surface), and combinations thereof.

Referring to FIG. 2C, a removable backing layer, 224, is deposited onto the master, 221, the elastomer, 222, and the protrusion, 223. The thickness of the removable backing layer, 225, is sufficient to completely cover the protrusion. As used herein, a “removable backing layer” refers to a material that can be reversibly attached to both the protrusion and the elastomeric material. The removable backing layer should be more easily removed from the protrusion of the master than the surface of the elastomer. In some embodiments, the surface of the protrusion can be pre-treated to facilitate the removal of the backing layer from the protrusion.

In some embodiments, the methods of the present invention further comprise: after disposing the backing layer, curing the backing layer. Methods suitable for curing the backing layer include, but are not limited to, exposing the backing layer to: thermal energy, electromagnetic radiation (e.g., UV light, IR light, etc.), electrical current, a plasma, oxidizing conditions and/or reagents, and combinations thereof.

In some embodiments, the removable backing layer further includes a rigid or semi-rigid support. In some embodiments, the rigid or semi-rigid support can be applied, 230, to the back surface of the removable backing layer. Referring to FIG. 2D, a rigid or semi-rigid support, 235, is deposited onto the removable backing layer, 234. The elastomeric material, 232, and the master, 231, are not in contact with the rigid or semi-rigid support. The stencil (comprising the elastomer, 232, the removable backing layer, 233, and the rigid or semi-rigid support, 234), is then removed, 240, from the master.

Referring to FIG. 2E, the stencil of the present invention, 241, comprising an elastomer, 242, having at least one opening therethrough, 243, a removable backing layer, 244, and a rigid or semi-rigid support, 245, is conformally contacted, 246, with a substrate, 247. In some embodiments, the conformal contacting of the stencil and the substrate can be promoted by at least one of: applying pressure to the back surface of the stencil, applying pressure to the back surface of the substrate, applying a vacuum to the interfacial region between the stencil and the substrate, wetting either one or both of the surfaces of the stencil and the substrate with a wetting agent (e.g., an agent capable of modifying the surface energy of one or both the substrate and the stencil), applying an adhesive to one or both of the surfaces of the stencil and the substrate, and combinations thereof. After the stencil is conformally contacted with the substrate, the rigid or semi-rigid support, 245, and the removable backing layer, 244, are removed, 250, from the elastomeric material, 242.

Referring to FIG. 2F, the elastomeric stencil of the present invention, 252, has been conformally contacted with a substrate, 251. The stencil includes an opening therethrough, 253, having a lateral dimension indicated by the magnitude of the vectors, 254 and 255, respectively. At least one lateral dimension of the opening in the stencil is about 50 μm or less.

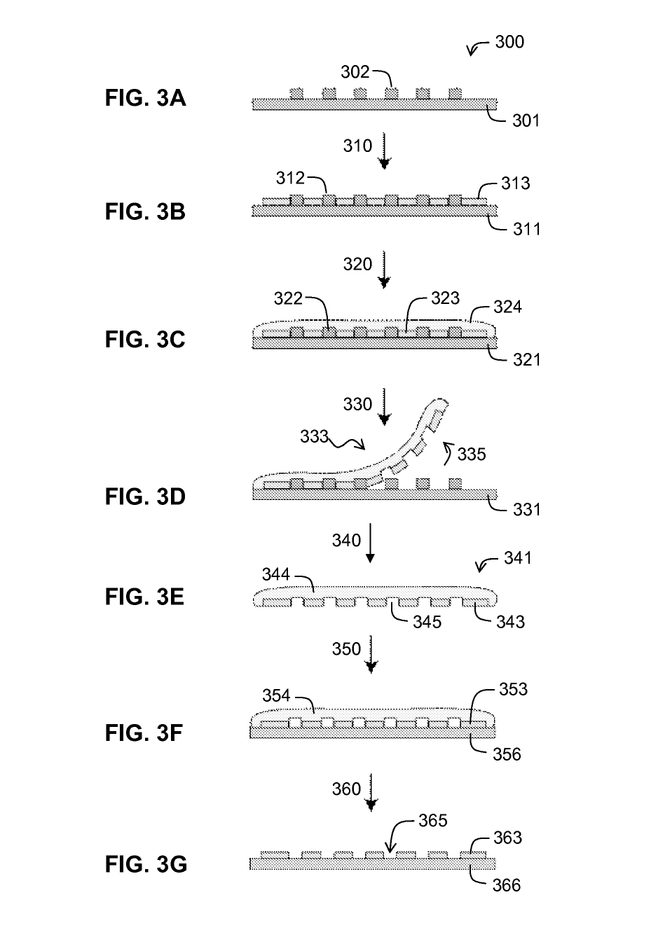

A second schematic cross-sectional representation of a method to make a stencil of the present invention and apply the stencil to a substrate for forming a pattern thereon is provided in FIGS. 3A-3G. Referring to FIG. 3A, a master, 300, comprising a material, 301, having at least one protrusion thereon, 302, is provided by a known method such as, for example, photolithographic patterning, mechanical machining, or the like.

An elastomeric material or an elastomeric precursor is then applied to the master, 310. Referring to FIG. 3B, an elastomeric material or an elastomeric precursor, 313, is provided that coats the material, 311, but which does not fully cover the protrusion, 312, thereby permitting the protrusion, 312, to extend through the elastomeric material, 313.

A removable backing layer is then applied, 320, to the elastomeric material and the master. Referring to FIG. 3C, a removable backing layer, 324, is deposited to cover both the elastomer, 323, and the protrusion, 322. In some embodiments, the removable backing layer can also contact and cover a surface of the master, 321. In some embodiments, the removable backing layer further includes a rigid or semi-rigid support.

The elastomeric stencil and backing layer are then removed, 330, from the master. Referring to FIG. 3D. In some embodiments, the elastomeric stencil, 333, is removed from the master, 331, by peeling away the elastomeric stencil. Any suitable method that retains the shape of the elastomeric stencil can be used to remove it from the master. In some embodiments, a solvent, suction, a pressurized gas, a plasma, and combinations thereof can be useful for removing the elastomeric stencil from the master.

The elastomeric stencil having a removable backing layer is thereby provided, 340. Referring to FIG. 3E, the elastomeric stencil of the present invention, 341, comprises an elastomer, 343, having at least one opening therethrough, 345, a removable backing layer, 344, and an optional rigid or semi-rigid support (not shown).

The elastomeric stencil is then conformally contacted, 350, with a substrate. Referring to FIG. 3F, the substrate, 356, is conformally contacted with the surface of the elastomeric stencil, 353. The removable backing layer, 354, can also contact the substrate.

The removable backing layer is then removed, 360, from the elastomeric stencil. Referring to FIG. 3G, the elastomeric stencil, 363, is in conformal contact with a substrate, 366. The stencil includes an opening therethrough, 365. At least one lateral dimension of the opening in the stencil is about 50 μm or less.

### Kits

In some embodiments, the present invention is directed to a kit for patterning a substrate, the kit comprising:
(a) an elastomeric stencil including:
   an elastomeric material having a front surface and a back surface including at least one opening therethrough, the opening defining a pattern in the surfaces of the elastomeric material, wherein the opening has a minimum lateral dimension of about 50 μm or less, and wherein the elastomeric material has a thickness not greater than ten times the minimum lateral dimension,
   a peelable protective layer adhered to the front surface of the elastomeric material, and
   a removable backing layer adhered to the back surface of the elastomeric material; and
(b) instructions directing patterning a substrate using the elastomeric stencil.

In some embodiments, the kit further comprises a reactive composition filling the at least one opening. The reactive composition can be held inside the at least opening by the peelable protective layer and removable backing layer. Kits including a reactive composition in the at least one opening enable the direct patterning of a substrate without the need to apply an additional reactive component to the backside of the stencil after conformally contacting the stencil with a substrate. In some embodiments, the kit comprising the reactive composition is stable under ambient storage conditions, or alternatively, the kit is stored in a controlled environment until the time of use.

In some embodiments, a kit comprises a non-permeable seal surrounding an outer edge of the elastomeric material. The non-permeable seal can prevent, for example, ambient vapors and gases from permeating the elastomeric material, and increase the shelf life of the kit. Additionally, the non-permeable seal can prevent a reactive composition from escaping from the kit during storage, as well as improving the stability of a reactive composition.

The kits comprise instructions relating to methods of using the kits to form patterns on a substrate. In some embodiments, the instructions can comprise a label or other printed matter. “Printed matter” can be, for example, one of a book, booklet, brochure or leaflet. Possible formats include, but are not limited to, a bullet point list, a list of frequently asked questions (FAQ) or a chart. Additionally, the information to be imparted can be illustrated in non-textual terms using pictures, graphics or other symbols. For example, printed matter can be in a form prescribed by a governmental agency regulating the manufacture, use or sale of chemical reagents (e.g., an Materials Safety Data Sheet), which notice reflects classification of any chemicals included with the kit. The printed matter can also contain information on the dangers associated with using the kit. In some embodiments, printed matter can be accompanied by a pre-recorded media device.

A “pre-recorded media device” can be, for example, a visual media device, such as a videotape cassette, a DVD (digital video disk), filmstrip, 35 mm movie or any other visual media device. Alternately, a pre-recorded media device can be an interactive software application, such as a CD-ROM (compact disk-read only memory) or floppy disk. Alternately, a pre-recorded media device can be an audio media device, such as a record, audiocassette or audio compact disk. The information contained on a pre-recorded media device can describe the use of the kit of the present invention for patterning a substrate.

In some embodiments, the instructions are presented in a format chosen from: an English-language text, a foreign-language text, a visual image, a chart, a telephone recording, a website, access to a live customer service representative, and any other format that would be apparent to one of ordinary skill in the art. In some embodiments, the instructions include a direction for use, appropriate age use, a warning, a telephone number or a website address.

### Substrates

The present invention provides methods for forming a feature in or on a substrate. Substrates suitable for patterning by the method of the present invention are not particularly limited by size, composition or geometry, and include any material having a surface capable of being contacted with a stencil. For example, the present invention is suitable for patterning planar (i.e., flat), non-planar (i.e., curved or complex substrates such as tetrahedrons, spheres, and the like), symmetric, and asymmetric objects and surfaces, and any combination thereof. The substrate can be homogeneous or heterogeneous in composition. Moreover, the methods are not limited by surface roughness or surface waviness, and are equally applicable to smooth, rough and wavy substrates, and substrates exhibiting heterogeneous surface morphology (e.g., substrates having varying degrees of smoothness, roughness and waviness).

Substrates suitable for patterning by the method of the present invention include, but are not limited to, metals, alloys, composites, crystalline materials, amorphous materials, conductors, semiconductors, optics, fibers, glasses, ceramics, zeolites, films, thin films, laminates, foils, plastics, polymers, minerals, biomaterials, living tissue, bone, and combinations thereof. In some embodiments, a material is selected from a porous variant of any of the above materials.

In some embodiments, a material to be patterned by the method of the present invention comprises a semiconductor, glass, or ceramic such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, undoped silica glass (SiO₂), fluorinated silica glass, borosilicate glass, borophosphorosilicate glass, organosilicate glass, porous organosilicate glass, silicon carbide, hydrogenated silicon carbide, silicon nitride, silicon carbonitride, silicon oxynitride, silicon oxycarbide, and combinations thereof.

In some embodiments, a material to be patterned by the method of the present invention comprises a flexible material, such as, but not limited to: a plastic, a composite, a laminate, a thin film, a metal foil, and combinations thereof. In some embodiments, the flexible material can be patterned by the method of the present invention in a reel-to-reel manner.

The present invention contemplates optimizing the performance, efficiency, cost, and speed of the method steps by selecting reactive compositions and substrates that are compatible with one another. For example, in some embodiments, a substrate can be selected based upon its optical properties, physical properties, thermal properties, electrical properties, and combinations thereof.

In some embodiments, a substrate is transparent to at least one type of radiation suitable for initiating a reaction of the reactive composition on the substrate. For example, a substrate transparent to ultraviolet light can be used with a reactive composition whose reaction can be initiated by ultraviolet light, which permits the reaction of a reactive composition on the front-surface of a substrate to be initiated by illuminating a back-surface of the substrate with ultraviolet light.

### Forming Surface Features

The present invention is directed to a method for forming a surface feature on a substrate, the method comprising:
(a) providing an elastomeric stencil having:
   an elastomeric material having a front surface and a back surface including an opening therethrough, the opening defining a pattern in the surfaces of the elastomeric material, wherein the opening has at least one lateral dimension of about 50 μm or less, and wherein the elastomeric material has a thickness not greater than ten times the minimum lateral dimension; and
   a removable backing layer adhered to the back surface of the elastomeric material;
(b) conformally contacting the front surface of the elastomeric stencil with a substrate;
(c) removing the backing layer from the elastomeric stencil;
(d) applying a reactive composition to the opening in the elastomeric stencil;
(e) reacting the reactive composition with the substrate to produce a surface feature thereon, wherein the lateral dimension of the opening in the elastomeric stencil defines a lateral dimension of the surface feature produced by the reacting; and
(f) separating the front surface of the elastomeric stencil from the patterned substrate.

A reactive composition can be applied to an opening in a stencil by methods known in the art such as, but not limited to, screen printing, ink jet printing, syringe deposition, spraying, spin coating, brushing, vapor depositing, plasma depositing, and exposing to a vapor source, light source, plasma source, and combinations thereof. In some embodiments, a reactive composition is poured onto the back surface of a stencil, and then a blade is moved transversely across the surface of the stencil to ensure that the openings in the stencil are completely and uniformly filled. The blade can also remove excess of the reactive composition from the surface of the stencil. Applying a reactive composition to a surface of a stencil can comprise rotating the stencil at about 100 revolutions per minute (rpm) to about 5,000 rpm, or about 1,000 rpm to about 3,000 rpm, while pouring or spraying the reactive composition onto the rotating stencil.

Applying a reactive composition to a stencil completely and uniformly fills the at least one opening in the surfaces of the stencil. Not being bound by any particular theory, as the lateral dimensions of the opening in the stencil become smaller, the viscosity of the reactive composition should be decreased and/or the thickness of the stencil should be decreased to ensure that the pattern in the openings in the stencil are filled uniformly. Non-uniform application of the reactive composition to the stencil can result in a failure to correctly and reproducibly produce surface features having the desired lateral dimensions.

In some embodiments, a reactive composition can be formulated to control its viscosity. In some embodiments, a reactive composition has a viscosity of about 0.1 cP to about 10,000 cP, about 1 cP to about 500 cP, about 1 cP to about 200 cP, or about 1 cP to about 100 cP. In some embodiments, the viscosity of a reactive composition is modified during one or more of an applying step, contacting step, reacting step, and combinations thereof.

Transfer of the reactive composition from the opening in the stencil to the substrate can be promoted by one or more interactions between the reactive composition and the surface of the stencil, between the reactive composition and the substrate, between the surface of the stencil and the substrate, and combinations thereof that promote adhesion of a reactive composition to the substrate. Not being bound by any particular theory, adhesion of a reactive composition to the substrate can be promoted by gravity, a Van der Waals interaction, a covalent bond, an ionic interaction, a hydrogen bond, a hydrophilic interaction, a hydrophobic interaction, a magnetic interaction, and combinations thereof. Conversely, the minimization of these interactions between a reactive composition and the surface of a stencil can facilitate transfer of the reactive composition from the surface of the stencil to the substrate.

In some embodiments, the present invention further comprises applying a pressure and/or a vacuum to the backside of either or both of the stencil and the substrate. In some embodiments, the application of pressure or vacuum can ensure that the reactive composition is substantially removed from between the surfaces of the stencil and substrate. In some embodiments, the application of pressure or vacuum can ensure that there is conformal contact between the surfaces of the stencil and the substrate. In some embodiments, the application of pressure or vacuum can minimize the presence of gas bubbles present between the surfaces of the stencil and the substrate, or gas bubbles present in the reactive composition. Not being bound by any particular theory, the removal of gas bubbles can facilitate in the reproducible formation of surface features having lateral dimensions of 50 μm or less. Furthermore, applying a pressure and/or a vacuum to the backside of either or both of the stencil and the substrate can facilitate conformal contact between the stencil and a substrate.

In some embodiments, the present invention further comprises pre-treating the substrate, the surface of a stencil, or a combination thereof. As used herein, “pre-treating” refers to chemically or physically modifying a surface prior to applying or reacting a reactive composition. Pre-treating can include selectively patterning, functionalizing, derivatizing, texturing, and the like. Pre-treating can further include, but is not limited to, cleaning, oxidizing, reducing, derivatizing, functionalizing, exposing a substrate to a reactive gas, plasma, thermal energy, ultraviolet radiation, and combinations thereof. Not being bound by any particular theory, pre-treating a substrate can increase or decrease an adhesive interaction between a reactive composition and the substrate, and facilitate the formation of surface features having a lateral dimension of about 50 μm or less.

For example, derivatizing a substrate with a polar functional group (e.g., oxidizing the substrate) can promote the wetting of the substrate by a hydrophilic reactive composition and deter surface wetting by a hydrophobic reactive composition. Moreover, hydrophobic and/or hydrophilic interactions can be used to prevent a reactive composition from penetrating into the body of a stencil. For example, derivatizing the surface of a stencil with a fluorocarbon functional group can facilitate the transfer of a reactive composition from the opening in the stencil to the substrate without swelling of the stencil.

The method of the present invention produces surface features by reacting a reactive composition with a substrate. As used herein, “reacting” refers to initiating a chemical reaction comprising at least one of: reacting one or more components present in the reactive composition with each other, reacting one or more components of a reactive composition with a substrate, reacting one or more components of a reactive composition with sub-surface region of a substrate, and combinations thereof.

In some embodiments, reacting comprises applying a reactive composition to a substrate (i.e., a reaction is initiated upon contact between a reactive composition and a substrate).

In some embodiments, reacting the reactive composition comprises a chemical reaction between the reactive composition and a functional group on the substrate, or a chemical reaction between the reactive composition and a functional group below the surface of the substrate. Thus, methods of the present invention comprise reacting a reactive composition not only with a substrate, but also with a substrate below its surface, thereby forming inset or inlaid features on a substrate. Not being bound by any particular theory, a component of a reactive composition can react with a substrate by reacting on the surface of the substrate, or penetrating and/or diffusing into the substrate. In some embodiments, the penetration of a reactive composition into a substrate can be facilitated by the application of physical pressure or vacuum to the backside of a stencil or the substrate.

Reaction between a reactive composition and a substrate can modify one or more properties of the substrate, wherein the change in properties is localized to the portion of the substrate that reacts with the reactive composition. For example, a reactive metal particle can penetrate a substrate, and upon reacting, modify the conductivity of the substrate in the area and/or volume where the reacting occurs. In some embodiments, a reactive composition can penetrate the surface of a substrate and react selectively to increase the porosity of the substrate in the volume wherein the reacting occurs. In some embodiments, a reactive composition can selectively react with a crystalline material to increase or decrease its volume, or change the interstitial spacing of a crystalline lattice.

In some embodiments, reacting a reactive composition comprises chemically reacting a functional group on a substrate with a component of the reactive composition. Not being bound by any particular theory, a reactive composition can also react with only the surface of a substrate (i.e., no penetration and reaction with the substrate occurs below the surface). In some embodiments, a patterning method wherein only the surface of a substrate is changed can be useful for subsequent self-aligned deposition reactions.

In some embodiments, reacting the reactive composition with a substrate can comprise reactions that propagate into the plane of the substrate, as well as reactions in the lateral plane of the substrate. For example, a reaction between an etchant and a substrate can comprise the etchant penetrating into the surface of the substrate in the vertical direction (i.e., orthogonal to the surface of the substrate), such that the lateral dimensions of the lowest point of the surface feature are approximately equal to the dimensions of the feature at the plane of the substrate.

In some embodiments, etching reactions also occur laterally between a reactive composition and a substrate, such that the lateral dimensions at the bottom of a surface feature are more narrow than the lateral dimensions of the feature at the plane of the substrate. As used herein, “undercut” refers to situations when the lateral dimensions of a surface feature are greater than the lateral dimensions of an opening in a stencil used to apply a reactive composition to the substrate. Typically, undercut is caused by reaction of a reactive composition with a substrate in a lateral dimension, and can lead to the formation of beveled edges on subtractive features.

In some embodiments, the time of reaction can be selected to enable the formation of subtractive surface features having minimum undercut, and lateral dimensions identical to the lateral dimensions of a stamp or elastomeric stencil used to apply the reactive composition to the substrate.

In some embodiments, the reactive compositions for use with the present invention are formulated to minimize the reaction in a lateral dimension of a substrate (i.e., to minimize undercut). For example, a reactive composition can be applied to a substrate that is transparent to UV light, wherein illumination of the reactive composition through the backside of the substrate initiates a reaction between the reactive composition and the substrate. In some embodiments, the reaction initiator can activate a reactive composition through the backside of a stencil.

In some embodiments, reacting a reactive composition comprises removing solvent from the reactive composition. Not being bound by any particular theory, the removal of solvent from a reactive composition can solidify the reactive composition, or catalyze cross-linking reactions between components of a reactive composition. In some embodiments, a solvent can be removed from a reactive composition without heating. Solvent removal can also be achieved by heating the substrate, reactive composition, stencil, and combinations thereof. Cross-linking reactions can be intramolecular or intermolecular, and can also occur between a component and the surface of the substrate.

In some embodiments, reacting the reactive composition comprises sintering metal particles present in the reactive composition. Not being bound by any particular theory, sintering is a process in which metal particles join to form a continuous structure within a surface feature without melting. Sintering be used to form both homogeneous and heterogeneous metal surface features.

In some embodiments, reacting comprises exposing a reactive composition to a reaction initiator. Reaction initiators suitable for use with the present invention include, but are not limited to, thermal energy, electromagnetic radiation, acoustic waves, an oxidizing or reducing plasma, an electron beam, a stoichiometric chemical reagent, a catalytic chemical reagent, an oxidizing or reducing reactive gas, an acid or a base (e.g., a decrease or increase in pH), an increase or decrease in pressure, an alternating or direct electrical current, agitation, sonication, friction, and combinations thereof. In some embodiments, reacting comprises exposing a reactive composition to multiple reaction initiators.

Electromagnetic radiation suitable for use as a reaction initiator can include, but is not limited to, microwave light, infrared light, visible light, ultraviolet light, x-rays, radiofrequency, and combinations thereof.

In some embodiments, the stencil is removed before reacting the reactive composition. In some embodiments, the stencil is removed after reacting the reactive composition. Not being bound by any particular theory, leaving the stencil in place during the reacting step can ensure reproducible surface features are formed with the desired lateral dimensions. For example, removing the stencil after the reacting can ensure the reactive composition does not spread across the substrate prior to or during the reacting.

In some embodiments, the method of the present invention further comprises: exposing an area of a substrate adjacent to a surface feature to a reactive composition that reacts with the adjacent surface area, but which is unreactive towards the surface feature. For example, after producing a surface feature comprising a masking component, the remaining substrate can be exposed to an etchant, such as a gaseous etchant, a liquid etchant, and combinations thereof.

In some embodiments, prior to conformally contacting an elastomeric stencil having a removable backing layer with a substrate, the substrate is patterned by a micro-contact printing method. For example, an ink can be applied to an elastomeric stamp having at least one indentation in the surface of the elastomeric stamp which defines a pattern, to form a coated elastomeric stamp, and the coated stamp is placed in conformal contact with the substrate. The ink is transferred from the surface of the coated elastomeric stamp that is in conformal contact with the substrate, while the substrate “contacting” the at least one indentation in the elastomeric stamp has no ink transferred to it. The ink adheres to the substrate, and can form at least one of a thin film, a monolayer, a bilayer, a self-assembled monolayer, and combinations thereof. In some embodiments the ink can react with the substrate. A reactive composition can then be applied to the substrate in a pattern determined by an elastomeric stencil, wherein the reactive composition is reactive towards either one of the exposed substrate or the substrate coated by the ink. The resulting patterned substrate includes a pattern having lateral dimensions determined by the pattern in the elastomeric stamp used to the apply the ink to the substrate as well as the pattern of the elastomeric stencil.

In some embodiments, the present invention further comprises after the reacting, applying a backing layer to the stencil. The backing layer can be the same or a different backing layer as that which was removed from the stencil during the removing.

### Surface Features

The present invention provides methods for forming a feature in or on a substrate. Substrates suitable for use with the present invention are not particularly limited by size, composition or geometry. For example, the present invention is suitable for patterning planar, curved, symmetric, and asymmetric objects and substrates, and any combination thereof. Additionally, the substrate can be homogeneous or heterogeneous in composition. The methods are also not limited by surface roughness or surface waviness, and are equally applicable to smooth, rough and wavy surfaces, and substrates exhibiting heterogeneous surface morphology (i.e., surfaces having varying degrees of smoothness, roughness and/or waviness).

As used herein, a “surface feature” refers to an area of a substrate that is contiguous with, and can be distinguished from, the areas of the substrate surrounding the feature. The term “surface feature” denotes a substrate having a pattern thereon (i.e., a patterned substrate), and as such the terms “surface feature” and “pattern” can be used interchangeably. In some embodiments, a surface feature can be distinguished from the areas of the substrate surrounding the feature based upon the topography of the surface feature, composition of the surface feature, or another property of the surface feature that differs from the surrounding substrate. Similarly, in some embodiments a patterned region of a substrate can be distinguished from an unpatterned area of a substrate based upon the topography, composition, or another property of the pattern that differs from the unpatterned areas of the substrate.

Surface features can be defined by their physical dimensions. All surface features have at least one lateral dimension. As used herein, a “lateral dimension” refers to a dimension of a surface feature that lies in the plane of a substrate. One or more lateral dimensions of a surface feature define, or can be used to define, the area of a surface that a surface feature occupies. Typical lateral dimensions of surface features include, but are not limited to: length, width, radius, diameter, and combinations thereof.

All surface features also have at least one dimension that can be described by a vector that lies out of the plane of the substrate. As used herein, “elevation” refers to the largest vertical distance between the plane of a substrate and the highest or lowest point on a surface feature. More generally, the elevation of an additive surface feature refers to its highest point relative to the plane of the substrate, the elevation of a subtractive surface feature refers to its lowest point relative to the plane of the substrate, and a conformal surface feature has an elevation of zero (i.e., is at the same height as the plane of the substrate).

Surface features produced by the methods of the present invention can generally be classified into three groups: additive features, conformal features, and subtractive features, based upon the elevation of the surface feature relative to the plane of the substrate.

Surface features produced by the methods of the present invention can be further classified into two-subgroups: penetrating and non-penetrating, based upon whether or not the base of a surface feature penetrates below the plane of the substrate. As used herein, the “penetration distance” refers to the distance between the lowest point of a surface feature and the height of the substrate adjacent to the surface feature. More generally, the penetration distance of a surface feature refers to its lowest point relative to the plane of the substrate. Thus, a feature is said to be “penetrating” when its lowest point is located below the plane of the substrate on which the feature is located, and a feature is said to be “non-penetrating” when the lowest point of the feature is located within or above the plane of the substrate. A non-penetrating surface feature can be said to have a penetration distance of zero.

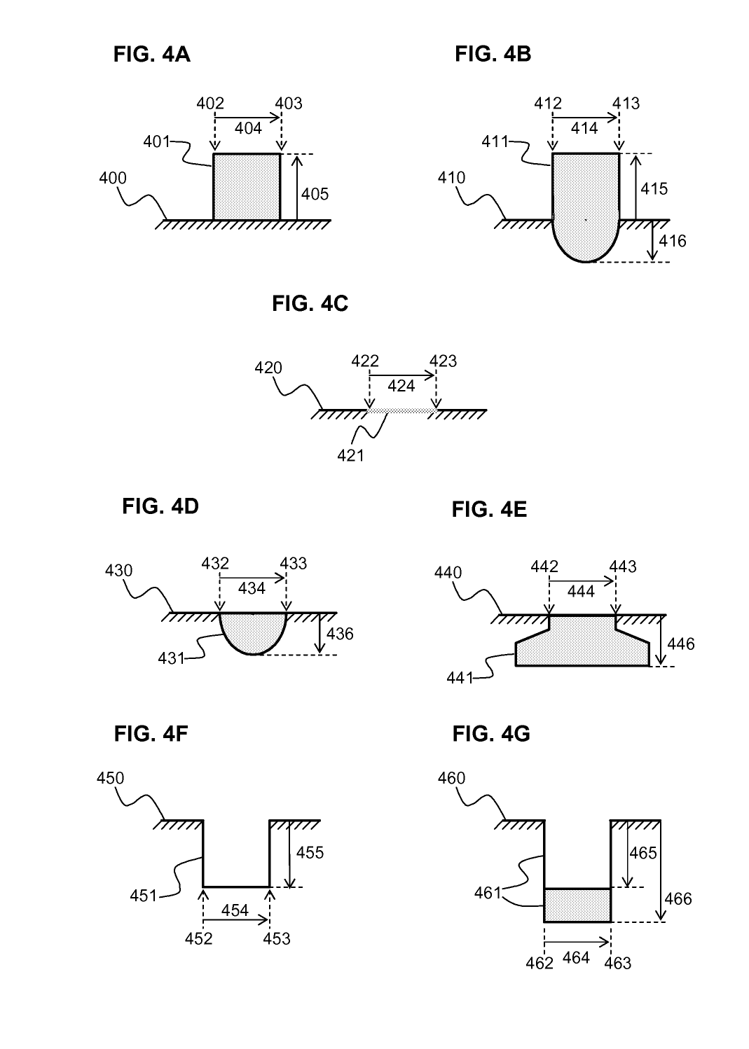

As used herein, an “additive feature” refers to a surface feature having an elevation that is above the plane of the substrate. Thus, the elevation of an additive feature is greater than the elevation of the surrounding substrate. FIG. 4A provides a cross-sectional schematic representation of a substrate, 400, having an “additive non-penetrating” surface feature, 401. The surface feature, 401, has a lateral dimension, 404, an elevation, 405, and a penetration distance of zero. FIG. 4B provides a cross-sectional schematic representation of a substrate, 410, having an “additive penetrating” surface feature, 411. The surface feature, 411, has a lateral dimension, 414, an elevation, 415, and a penetration distance, 416.

As used herein, a “conformal feature” refers to a surface feature having an elevation that is even with the plane of the substrate. Thus, a conformal feature has substantially the same topography as the surrounding substrate. As used herein, a “conformal non-penetrating” surface feature refers to a surface feature that is purely on the substrate. For example, a reactive composition that reacts with the exposed functional groups of a substrate such as, for example, by oxidizing, reducing, or functionalizing the groups, would form a conformal non-penetrating surface feature. FIG. 4C provides a cross-sectional schematic representation of a substrate, 420, having a “conformal non-penetrating” surface feature, 421. The surface feature, 421, has a lateral dimension, 424, and has an elevation of zero and a penetration distance of zero. FIG. 4D provides a cross-sectional schematic representation of a substrate, 430, having a “conformal penetrating” surface feature, 331. The surface feature, 431, has a lateral dimension, 434, an elevation of zero, and penetration distance, 436. FIG. 4E provides a cross-sectional schematic representation of a substrate, 440, having a “conformal penetrating” surface feature, 441. The surface feature, 441, has a lateral dimension, 444, an elevation of zero, and penetration distance, 446.

As used herein, a “subtractive feature” refers to a surface feature having an elevation that is below the plane of the substrate. FIG. 4F provides a cross-sectional schematic representation of a substrate, 450, having a “subtractive non-penetrating” surface feature, 451. The surface feature, 451, has a lateral dimension, 454, an elevation, 455, and penetration distance of zero. FIG. 4G provides a cross-sectional schematic representation of a substrate, 460, having a “subtractive penetrating” surface feature, 461. The surface feature, 461, has a lateral dimension, 464, an elevation, 465, and a penetration distance, 466.

Surface features can be further differentiated based upon their composition and utility. For example, surface features produced by a method of the present invention include structural surface features, conductive surface features, semi-conductive surface features, insulating surface features, and masking surface features.

As used herein, a “structural feature” refers to surface feature having a composition similar or identical to the composition of the substrate on which the surface feature is produced.

As used herein, a “conductive feature” refers to a surface feature having a composition that is electrically conductive, or electrically semi-conductive. Electrically semi-conductive features include surface features whose electrical conductivity can be modified based upon an external stimulus such as, but not limited to, an electrical field, a magnetic field, a temperature change, a pressure change, exposure to radiation, and combinations thereof.

As used herein, an “insulating feature” refers to a surface feature having a composition that is electrically insulating.

As used herein, a “masking feature” refers to a surface feature that has composition that is inert to reaction with a reagent that is reactive towards an area of a substrate adjacent to and surrounding the surface feature. Thus, a masking feature can be used to protect a substrate or a selected area of a substrate during subsequent steps, such as, but not limited to, etching, deposition, implantation, and surface treatment steps. In some embodiments, a masking feature is removed during or after subsequent steps.

### Feature Size and Measurement

A surface feature produced by a method of the present invention has lateral and vertical dimensions that are typically defined in units of length, such as angstroms (Å), nanometers (nm), microns (μm), millimeters (mm), centimeters (cm), etc.

When the substrate is planar, a lateral dimension of a surface feature is the magnitude of a vector between two points located on opposite sides of a surface feature, wherein the two points are in the plane of the substrate, and wherein the vector is parallel to the plane of the substrate. In some embodiments, two points used to determine a lateral dimension of a symmetric surface also lie on a mirror plane of the symmetric feature. In some embodiments, a lateral dimension of an asymmetric surface feature can be determined by aligning the vector orthogonally to at least one edge of the surface feature.

For example, in FIG. 4A-4G points lying in the plane of the substrate and on opposite sides of the surface features, 401, 411, 421, 431, 441, 451 and 461, are shown by dashed arrows, 402 and 403; 412 and 413; 422 and 423; 432 and 433; 442 and 443; 452 and 453, and 462 and 463, respectively. The lateral dimension of these surface features is shown by the magnitude of the vectors 404, 414, 424, 434, 444, 454 and 464, respectively.

A substrate is “curved” when the substrate has a radius of curvature that is non-zero over a distance of 100 μm or more, or over a distance of 1 mm or more. For a curved substrate, a lateral dimension is defined as the magnitude of a segment of the circumference of a circle connecting two points on opposite sides of the surface feature, wherein the circle has a radius equal to the radius of curvature of the substrate. A lateral dimension of a curved substrate having multiple or undulating curvature, or waviness, can be determined by summing the magnitude of segments from multiple circles.

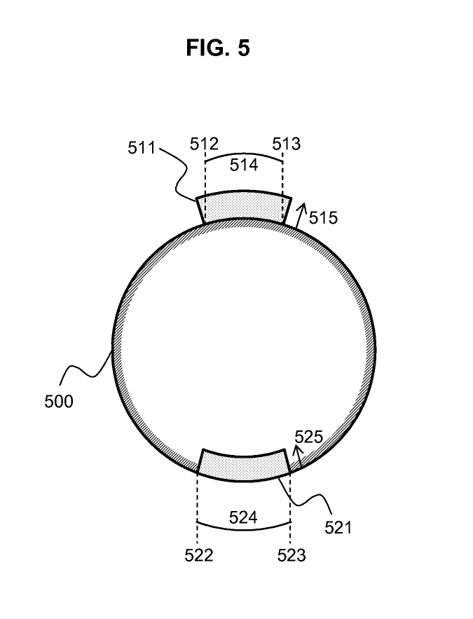

FIG. 5 displays a cross-sectional schematic of a curved substrate, 500, having an additive non-penetrating surface feature, 511, and a conformal penetrating surface feature, 521. A lateral dimension of the additive non-penetrating surface feature, 511, is equivalent to the length of the line segment, 514, which can connect points 512 and 513. Similarly, a lateral dimension of the conformal penetrating surface feature, 521, is equivalent to the length of the line segment, 524, which connect points 522 and 523.

In some embodiments, a surface feature produced by a method of the present invention has at least one lateral dimension of about 40 nm to about 50 μm, about 40 nm to about 40 μm, about 40 nm to about 30 μm, about 40 nm to about 20 μm, about 40 nm to about 10 μm, about 40 nm to about 5 μm, about 40 nm to about 1 μm, about 100 nm to about 50 μm, about 100 nm to about 40 μm, about 100 nm to about 30 μm, about 100 nm to about 20 μm, about 100 nm to about 10 μm, about 100 nm to about 5 μm, about 100 nm to about 1 μm, about 500 nm to about 50 μm, about 500 nm to about 40 μm, about 500 nm to about 30 μm, about 500 nm to about 20 μm, about 500 nm to about 10 μm, about 500 nm to about 5 μm, about 500 nm to about 1 μm, about 1 μm to about 50 μm, about 1 μm to about 40 μm, about 1 μm to about 30 μm, about 1 μm to about 20 μm, about 1 μm to about 10 μm, about 1 μm to about 5 μm, or about 1 μm.

The lateral dimension of a surface feature produced by a method of the present invention is defined by the lateral dimension of an opening in the elastomeric stencil. As used herein, the lateral dimension of an opening in the elastomeric stencil can refer to either an opening in the surface of a stencil, or for a floating stencil, to the distance between areas of the stencil (e.g., parallel lines, and any other stencil features that are physically disconnected from one another).

In some embodiments, a feature produced by a method of the present invention has an elevation or penetration distance of about 3 A to about 100 μm, about 3 Å to about 50 μm, about 3 Å to about 10 μm, about 3 Å to about 1 μm, about 3 Å to about 500 nm, about 3 Å to about 100 nm, about 3 Å to about 50 nm, about 3 Å to about 10 nm, about 3 Å to about 1 nm, about 1 nm to about 100 μm, about 1 nm to about 50 μm, about 1 nm to about 10 μm, about 1 nm to about 1 μm, about 1 nm to about 500 nm, about 1 nm to about 100 nm, about 1 nm to about 50 nm, about 1 nm to about 10 nm, about 10 nm to about 100 μm, about 10 nm to about 50 μm, about 10 nm to about 10 μm, about 10 nm to about 1 μm, about 10 nm to about 500 nm, about 10 nm to about 100 nm, about 10 nm to about 50 nm, about 50 nm to about 100 μm, about 50 nm to about 50 μm, about 50 nm to about 10 μm, about 50 nm to about 1 μm, about 50 nm to about 500 nm, about 50 nm to about 100 nm, about 100 nm to about 100 μm, about 100 nm to about 50 μm, about 100 nm to about 10 μm, about 100 nm to about 1 μm, or about 100 nm to about 500 nm above or below the plane of a substrate.

In some embodiments, a surface feature produced by a method of the present invention has an aspect ratio (i.e., a ratio of either one or both of the elevation and/or penetration distance to a lateral dimension) of about 10:1 to about 1:10, about 8:1 to about 1:8, about 5:1 to about 1:5, about 2:1 to about 1:2, or about 1:1.

A lateral and/or vertical dimension of an additive or subtractive surface feature can be determined using an analytical method that can measure substrate topography such as, for example, scanning mode atomic force microscopy (AFM) or profilometry. Conformal surface features cannot typically be detected by profilometry methods. However, if the surface of a conformal surface feature is terminated with a functional group whose polarity differs from that of the surrounding surface areas, a lateral dimension of the surface feature can be determined using, for example, tapping mode AFM, functionalized AFM, or scanning probe microscopy.

Surface features can also be identified based upon a property such as, but not limited to, conductivity, resistivity, density, permeability, porosity, hardness, and combinations thereof using, for example, scanning probe microscopy.

In some embodiments, a surface feature can be differentiated from the substrate, for example, scanning electron microscopy or transmission electron microscopy.

In preferable embodiments of the present invention a surface feature has a different composition or morphology compared to the surrounding substrate. Thus, surface analytical methods can be employed to determine both the composition of the surface feature, as well as the lateral dimension of the surface feature. Analytical methods suitable for determining the composition and lateral and vertical dimensions of a surface feature include, but are not limited to, Auger electron spectroscopy, energy dispersive x-ray spectroscopy, micro-Fourier transform infrared spectroscopy, particle induced x-ray emission, Raman spectroscopy, x-ray diffraction, x-ray fluorescence, laser ablation inductively coupled plasma mass spectrometry, Rutherford backscattering spectrometry/Hydrogen forward scattering, secondary ion mass spectrometry, time-of-flight secondary ion mass spectrometry, x-ray photoelectron spectroscopy, and combinations thereof.

### Reactive Compositions

As used herein, a “reactive composition” refers to a composition suitable for reacting with a substrate. In some embodiments, the reactive composition includes more than one component and is a “heterogeneous composition” having more than one excipient or component. As used herein, “reactive composition” can refer to a liquid, a vapor, a gas, a plasma, a solid, a paste, an ink, a gel, a cream, a glue, an adhesive, and combinations thereof. In some embodiments, a reactive composition for use with the present invention has a physical property, an electrical property, a chemical property, and combinations thereof that can be controlled by one or more external conditions such as temperature, pressure, electrical current, and the like.

As used herein, “reacting” refers to providing a reactive composition that interacts with a substrate, for example, to etch at an area of the substrate, to deposit a material on an area of the substrate, to modify the functional groups at an area of the substrate, to react a species with an area of the substrate, and combinations thereof.

In some embodiments, a reactive composition suitable for use with the present invention comprises a solvent and a thickening agent. In some embodiments, the combination of a solvent and a thickening agent can be selected to adjust the viscosity of a reactive composition. In some embodiments, a reactive composition for use with the present invention has a viscosity that can be adjusted from about 0.1 cP to about 10,000 cP.

Solvents suitable for use in a reactive composition of the present invention include, organic solvents, inorganic solvents (e.g., water), solubilizing agents, molten metals, and combinations thereof.

Thickening agents suitable for use with a reactive composition of the present invention include, but are not limited to, metal salts of polymers having ionizable side groups, dendrimers, colloids, and combinations thereof.

In some embodiments, as the lateral dimensions of the desired surface features decrease it is necessary to reduce the particle size or physical length of components in the reactive composition. For example, for surface features having a lateral dimension of about 100 nm or less it can be necessary to reduce or eliminate polymeric components from a reactive composition.

In some embodiments, a reactive composition suitable for use with the present invention comprises an etchant. As used herein, an “etchant” refers to a component that can react with a substrate to remove a portion of the substrate. Thus, an etchant can be used to form a subtractive feature, and in reacting with a substrate, form at least one of a volatile material that can diffuse away from the substrate, or a residue, particulate, or fragment that can be removed from the substrate by, for example, a rinsing or cleaning process.

The composition and/or morphology of a substrate that can react with an etchant is not particularly limited. Subtractive features formed by reacting an etchant with a substrate are also not particularly limited so long as the material that reacts with the etchant can be removed from the resulting subtractive surface feature. Not being bound by any particular theory, an etchant can remove material from a substrate by reacting with the substrate to form a volatile product, a residue, a particulate, or a fragment that can, for example, be removed from the substrate by a rinsing or cleaning process. For example, in some embodiments an etchant can react with a metal or metal oxide substrate to form a volatile fluorinated metal species. In some embodiments, an etchant can react with a substrate to form an ionic species that is water soluble. Additional methods suitable for removing a residue or particulate formed by reaction of an etchant with a substrate are disclosed in U.S. Pat. No. 5,894,853, which is incorporated herein by reference in its entirety.

Etchants suitable for use with the present invention include, but are not limited to, an acidic etchant, a basic etchant, a fluoride-based etchant, and combinations thereof. Reactive compositions containing an etchant that are suitable for use with the present invention are disclosed in, for example, U.S. Pat. Nos. 5,688,366 and 6,388,187; and U.S. Patent Appl. Pub. Nos. 2003/0160026; 2004/0063326; 2004/0110393; and 2005/0247674, which are herein incorporated by reference in their entirety.

In some embodiments, a reactive composition further comprises a species that has a chemical interaction with a substrate. In some embodiments, a reactive composition penetrates or diffuses into the body of a substrate. In some embodiments, a reactive composition transforms, binds, or promotes binding to exposed functional groups on the surface of a substrate. Reactive compositions suitable for use with the present invention further include ions, free radicals, metals, acids, bases, metal salts, organic reagents, and combinations thereof.

In some embodiments, a reactive composition further comprises a conductor. As used herein, a “conductor” refers to a compound or species that can transfer or move electrical charge and also includes semiconductors and the like. Conductors suitable for use with the present invention include, but are not limited to, a metal, a nanoparticle, a polymer, a cream solder, a resin, and combinations thereof. Semiconductors suitable for use with the present invention include, but are not limited to, organic semiconductors, inorganic semiconductors, and combinations thereof.

Metals suitable for use with the present invention include, but are not limited to, a transition metal, aluminum, silicon, phosphorous, gallium, germanium, indium, tin, antimony, lead, bismuth, alloys thereof, and combinations thereof. In some embodiments, a metal is present as a nanoparticle (i.e., a particle having a diameter of 100 nm or less, or about 0.5 nm to about 100 nm). Nanoparticles suitable for use with the present invention can be homogeneous, multilayered, functionalized, and combinations thereof.

Organic semiconductors suitable for use with the present invention include, but are not limited to, arylene vinylene polymer, polyphenylenevinylene, polyacetylene, polythiophene, polyimidazole, tetracene, pentacene, hexacene, perylene, terylene, quaterylene, coronene, and combinations thereof.

Reactive compositions comprising conductors suitable for use with the present invention are further disclosed in U.S. Pat. Nos. 5,504,015; 5,296,043; and 6,703,295 and U.S. Patent Appl. Pub. No. 2005/0115604, which are incorporated herein by reference in their entirety.

In some embodiments, a reactive composition further comprises an insulator. As used herein, an “insulator” refers to a compound or species that is resistant to the movement or transfer of electrical charge. In some embodiments, an insulator has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulators suitable for use with the present invention include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, and combinations thereof. In some embodiments, an insulator is present in a reactive composition in a concentration of about 1% to about 80% by weight of the reactive composition.

In some embodiments, a reactive composition further comprises a masking component. As used herein, a “masking component” refers to a compound or species that upon reacting forms a surface feature resistant to a species capable of reacting with the surrounding substrate. Masking components suitable for use with the present invention include materials commonly employed in traditional photolithography methods as “resists” (e.g., photoresists). Masking components suitable for use with the present invention include, but are not limited to, cross-linked aromatic and aliphatic polymers, non-conjugated aromatic polymers and copolymers, polyethers, polyesters, copolymers of C₁-C₈ alkyl methacrylates and acrylic acid, copolymers of paralyne, and combinations thereof. In some embodiments, a masking component is present in a reactive composition in a concentration of about 5% to about 98% by weight of the reactive composition.

In some embodiments, a reactive composition comprises a conductor and a reactive composition. For example, a reactive composition present in the reactive composition can promote at least one of: penetration of a conductor into a substrate, reaction between the conductor and a substrate, adhesion between a conductive feature and a substrate, promoting electrical contact between a conductive feature and a substrate, and combinations thereof. Surface features formed by this method include additive non-penetrating, additive penetrating, subtractive penetrating, and conformal penetrating surface features.

In some embodiments, a reactive composition comprises an etchant and a conductor, for example, that can be used to produce a subtractive surface feature having a conductive feature inset therein.

In some embodiments, a reactive composition comprises an insulator and a reactive composition. For example, a reactive composition can promote at least one of: penetration of an insulator into a substrate, reaction between the insulator and a substrate, adhesion between an insulating feature and a substrate, promoting electrical contact between an insulating feature and a substrate, and combinations thereof. Surface features formed by the present method include: additive non-penetrating, additive penetrating, subtractive penetrating, and conformal penetrating surface features.

In some embodiments, a reactive composition comprises an etchant and an insulator, for example, that can be used to produce a subtractive surface feature having an insulating feature inset therein.

In some embodiments, a reactive composition comprises a conductor and a masking component, for example, that can be used to produce an electrically conductive masking feature on a substrate.

### EXAMPLES

### Example 1

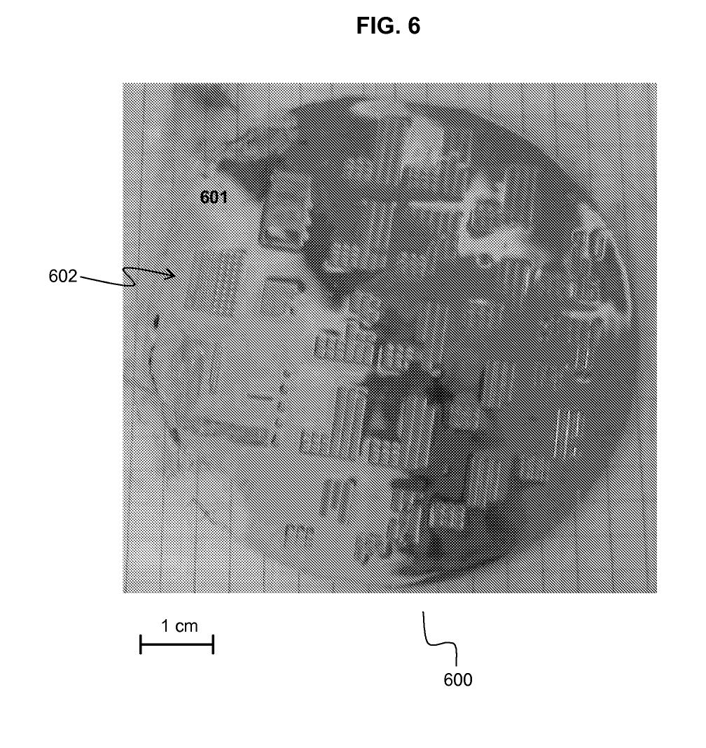

An elastomeric stencil having a removable backing was prepared as follows. A photoimageable polymer NANO™ SU-8 (Microchem Corp., Newton, Mass.) was spin-coated onto a 100 μm silicon wafer, exposed to an image projected using 365 nm light, and developed. The resulting pattern was then filled with poly(dimethylsiloxane) precursor, which was cross-linked by heating to 90° C. for 15 minutes under an air atmosphere. The resulting elastomer had a thickness of 30 μm. The cured elastomer and the master were then coated with a poly(vinylacetate) solution and allowed to dry for 20 minutes at 90° C. The resulting elastomeric stencil having a removable backing was then peeled away from the master and conformally contacted with a gold-coated mylar film (75 mm). Water was then applied to the backside of the elastomeric stencil to dissolve the removable backing layer. The substrate was then wet etched using a KI/I₂ etch bath. The resulting substrate is shown in FIG. 6. The patterned substrate, 600, was patterned by a single etching step to provide both patterned areas, 602, and areas of the substrate that were protected from the etch bath by the elastomeric stencil, 601. The elastomeric stencil was then removed by peeling it back from the patterned substrate.

### Example 2

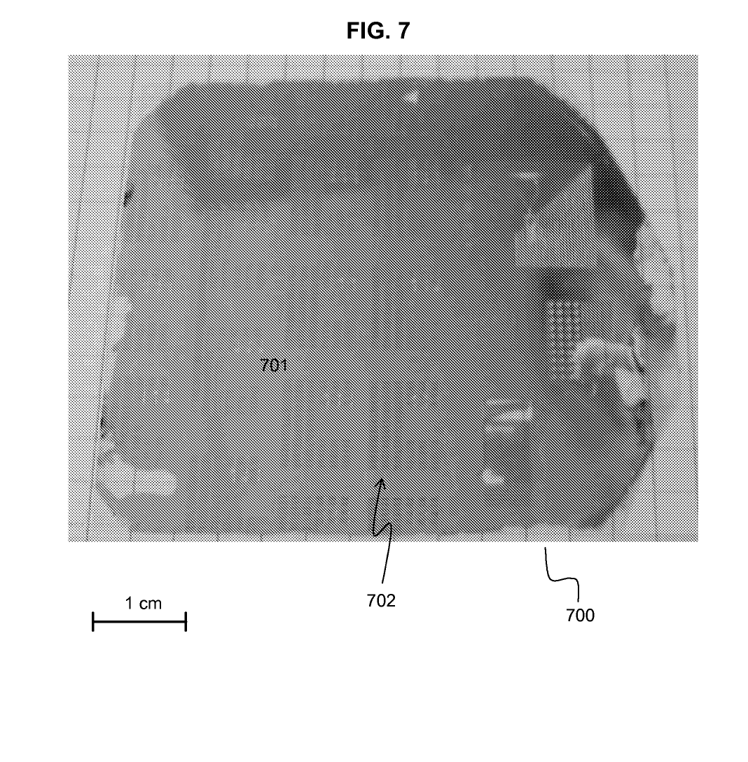

An elastomeric stencil was prepared by the method outlined in Example 1 (above), except that the elastomer had a thickness of 15 μm. The resulting substrate patterned using the stamp of Example 2 is shown in FIG. 7. The patterned substrate, 700, was patterned by a single etching step to provide both patterned areas, 702, and areas of the substrate that were protected from the etch bath by the elastomeric stencil, 701. The elastomeric stencil was then removed by peeling it back from the patterned substrate.

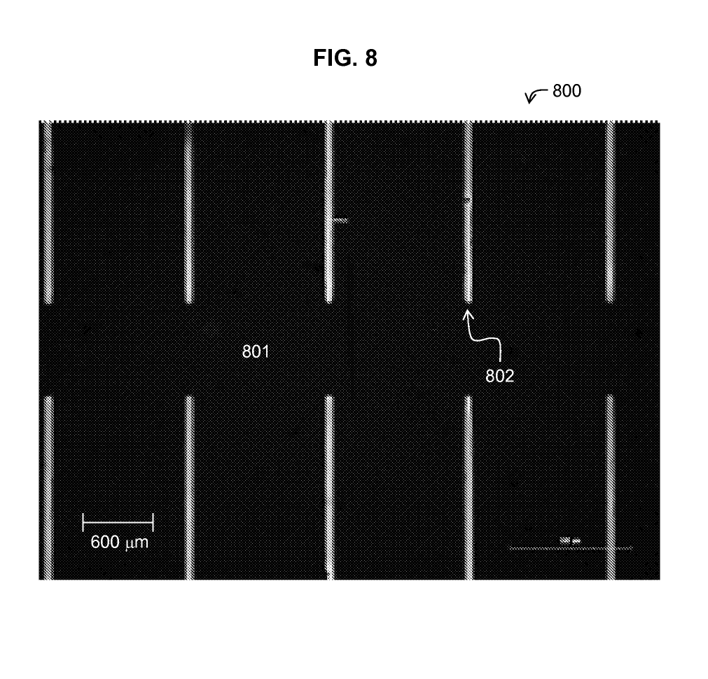

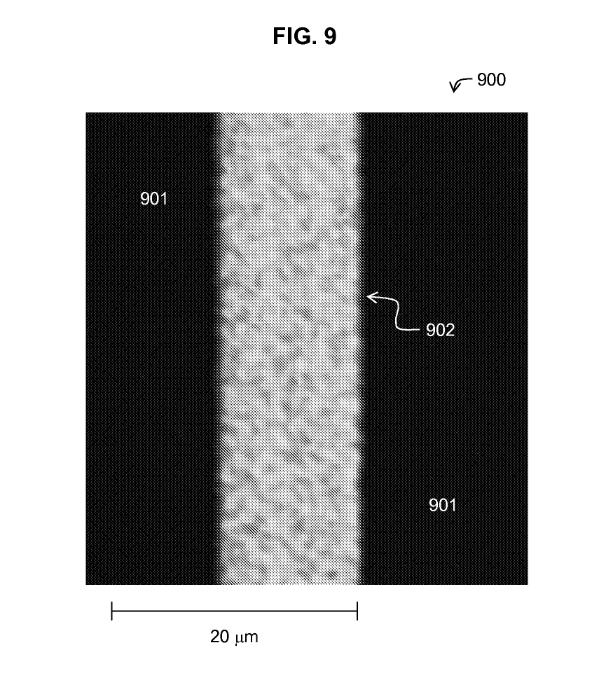

Optical microscope images of the substrate patterned in Example 1 are shown in FIGS. 8 and 9. FIG. 8 shows an area of the substrate, 800, having 25 μm-wide lines, 802, etched in the gold coating, 801. FIG. 9 shows an area of the substrate, 900, having an 11 μm-wide line, 902, etched in the gold coating, 901.

### Example 3

An elastomeric stencil was prepared as described in Example 1 (above). The cured elastomer and the master were then coated with a poly(vinylalcohol) solution and allowed to dry for 20 minutes at 90° C. The resulting elastomeric stencil having a removable backing was then peeled away from the master and conformally contacted with a gold-coated mylar film (75 mm). Water was then applied to the backside of the elastomeric stencil to dissolve the removable backing layer. The substrate was then patterned (wet etched) by exposure to a KI/I₂ solution. The elastomeric stencil was then removed by peeling it back from the patterned substrate.

### Conclusion

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method for forming a surface feature on a substrate, the method comprising:
(a) providing an elastomeric stencil having:
an elastomeric material having a front surface and a back surface including an opening therethrough, the opening defining a pattern in the surfaces of the elastomeric material, wherein the opening has a minimum lateral dimension of about 50 μm or less, and wherein the elastomeric material has a thickness not greater than ten times the minimum lateral dimension; and
a removable backing layer adhered to the back surface of the elastomeric material;
(b) conformally contacting the front surface of the elastomeric stencil with a substrate;
(c) removing the backing layer from the elastomeric stencil;
(d) applying a reactive composition to the opening in the elastomeric stencil;
(e) reacting the reactive composition with the substrate to produce a surface feature thereon, wherein the lateral dimension of the opening in the elastomeric stencil defines a lateral dimension of the surface feature produced by the reacting; and
(f) separating the front surface of the elastomeric stencil from the patterned substrate.

2. The method of claim 1, wherein the removing further comprises: exposing the backing layer to a solvent.

3. The method of claim 1, wherein the front surface of the elastomeric material has a surface area of about 500 mm² or more.

4. The method of claim 1, wherein the conformal contacting is promoted by at least one of: applying pressure to the back of the elastomeric stencil, applying a vacuum to the space between the elastomeric stencil and the substrate, wetting one or both of the surfaces of the elastomeric stencil and the substrate, applying an adhesive to one or both of the elastomeric stencil and the substrate, and combinations thereof.

5. The method of claim 1, wherein the elastomeric material is substantially homogeneous.

6. A product prepared by the method of claim 1.

7. A method for forming an elastomeric stencil, the method comprising:
(a) providing a master having a protrusion thereon having at least one lateral dimension of about 50 μm or less;
(b) providing an elastomeric material on the master, wherein the elastomeric material includes a front surface in contact with the master and a back surface, and wherein the elastomeric material has a thickness less than the elevation of the at least one protrusion;
(c) disposing a backing layer onto the elastomeric material to substantially cover both the elastomeric material and the at least one protrusion, wherein the backing layer and the elastomeric material are reversibly bonded; and
(d) separating the elastomeric material and backing layer from the substrate, thereby providing the elastomeric stencil, wherein the an elastomeric material has a front surface and a back surface including an opening therethrough, the opening defining a pattern in the surfaces of the elastomer, wherein the opening has a lateral dimension defined by the protrusion, and wherein the elastomeric material has a thickness not greater than ten times the minimum lateral dimension.

8. The method of claim 7, wherein the providing an elastomeric material comprises disposing an elastomeric precursor layer onto the master, wherein the precursor layer has a thickness less than the elevation of the at least one protrusion, and reacting the elastomeric precursor layer to provide the elastomer.

9. The method of claim 7, further comprising: after the disposing, curing the backing layer.

10. The method of claim 8, wherein the curing comprises at least one of: exposing to thermal energy, exposing to UV light, exposing to electrical current, exposing to IR light, exposing to a plasma, exposing to oxidizing reagents, and combinations thereof.

11. The method of claim 7, wherein the backing layer includes a rigid or semi-rigid support.

12. The method of claim 7, further comprising: after the disposing, adhering a rigid or semi-rigid support layer to an outer surface of the backing layer.

13. The method of claim 7, wherein the front surface of the elastomeric material has a surface area of about 500 mm² or more.

14. A kit for patterning a substrate, the kit comprising:
an elastomeric stencil including:
an elastomeric material having a front surface and a back surface including an opening therethrough, the opening defining a pattern in the surfaces of the elastomeric material, wherein the opening has a minimum lateral dimension of about 50 μm or less, and wherein the elastomeric material has a thickness not greater than ten times the minimum lateral dimension;
a peelable protective layer adhered to the front surface of the elastomeric material; and
a removable backing layer adhered to the back surface of the elastomeric material; and
instructions directing patterning a substrate using the elastomeric stencil.

15. The kit of claim 14, wherein the front surface of the elastomeric material has an area of about 500 mm² or more.

16. The kit of claim 14, wherein the removable backing layer includes a rigid or semi-rigid support.

17. The kit of claim 14, further comprising a rigid or semi-rigid support layer adhered to an outer surface of the removable backing layer.

18. The kit of claim 14, further comprising a non-permeable seal surrounding an outer edge of the elastomeric material.

19. The kit of claim 14, further comprising a reactive composition filling the at least one opening.
